(19) United States
(12) Patent Application Publication
(10) Pub. No.: US 2026/0226339 A1
(43) Pub. Date: Aug. 6, 2026

(54) PLUGGING AGENT COMPOSITION AND USE THEREOF, AND HYDROCARBON RESERVOIR PLUGGING METHOD

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD, Beijing (CN)

(72) Inventors: Xia MIAO, Beijing (CN); Lei CHEN, Beijing (CN); Mu WANG, Beijing (CN); Xiaojiang LI, Beijing (CN); Lishuang WANG, Beijing (CN); Xiaojing WANG, Beijing (CN); Jian LIU, Beijing (CN); Min ZENG, Beijing (CN); Haoya LIU, Beijing (CN); Dawei XU, Beijing (CN)

(21) Appl. No.: 19/125,730

(22) PCT Filed: Oct. 31, 2023
(86) PCT No.: PCT/CN2023/128543

§ 371 Date: Apr. 29, 2025

(30) Foreign Application Priority Data
Oct. 31, 2022 (CN) 202211366131.2

(51) Int. Cl. C09K 8/512

(52) U.S. Cl. CPC C09K 8/512; C09K 2208/10; C09K 2208/18

(57) ABSTRACT

A plugging agent composition and a use thereof, and a hydrocarbon reservoir plugging method are provided. The plugging agent composition contains a polymer latex and a stabilizer. The stabilizer has a cross-linkable group and/or a couplable group that are/is cross-linked or coupled in the presence of a crack and/or a leakage point, so that the polymer latex is condensed and cured. The plugging agent composition is a smart pressure-sensitive lost circulation control material, which can address leaks promptly as the leaks occur and does not work unless there is a leak; and compared with an existing latex-demulsified lost circulation control material, there is no need to use metal cations for demulsification, and the plugging agent composition can penetrate into cracks for plugging, and can plug cracks of different sizes from nanometers to millimeters.

### CROSS-REFERENCE TO RELATED APPLICATIONS

The application claims the benefit of the Chinese patent application No. “202211366131.2”, filed on Oct. 31, 2022, the contents of which are specifically and entirely incorporated herein by reference.

### FIELD

The present disclosure relates to the lost circulation control field of drilling and completion well, and in particular to a plugging agent composition and a use thereof and a hydrocarbon reservoir plugging method.

### BACKGROUND

Drilling well-lost circulation is a phenomenon in which a large amount of drilling fluid leaks into the drilled formations during the well-drilling process, and is widely encountered in oilfields at home and abroad, lost circulation imposes serious hazards to the oil & gas exploration, development, and drilling operations, threats the safe production of oilfields.

The current lost circulation control materials can be classified into conventional lost circulation control materials and smart lost circulation control materials. The conventional lost circulation control materials mainly adopt bridge blinding, and suffer from limitations in terms of the use procedure and the plugging effect, due to difficulty in detecting the circumstance of the lost circulation layer. Among the smart lost circulation control materials, both the temperature-sensitive lost circulation control materials and the shear-crosslinked lost circulation control materials require pre-setting of temperature or shear stress for the lost circulation circumstance, it is difficult to effectively plug the unknown lost circulation formation. In contrast, the pressure-sensitive lost circulation control materials do not require pre-setting of lost circulation formation and can recognize and plug the lost circulation formation in real time. The existing pressure-sensitive lost circulation control materials mainly use a salting-out process for demulsification, which requires that salt is added into the latex as a demulsifier to cause curing of the latex thereby plugging the cracks, but the addition of salt will cause residual metal cations, which cause a significantly adverse effect on the properties of rubber lost circulation control material formed after demulsification, and the curing time of latex during the salting-out process is short, which does not provide the lost circulation control material fluid with an opportunity to penetrate deeply into the cracks, causes a “door-sealing” type plugging, and it is subjected to some limitations on the size of cracks to be plugged.

Therefore, it is urgent to provide a novel lost circulation control material for well drilling.

### SUMMARY

The present disclosure aims to overcome the defects in the prior art that the plugging agent uses a salt to facilitate curing of latex, the residual metal cations have a large adverse effect on the properties of the lost circulation control material formed after curing of latex, the “door-sealing” type plugging results in the limited plugging effect, and has some limitations on the size of cracks to be plugged, and provides a plugging agent composition and a use thereof, and a hydrocarbon reservoir plugging method, wherein the plugging agent composition comprises a stabilizer having a dual function of “stabilization” or “demulsification” on polymer latex depending on the pressure change conditions, such that the polymer latex starts the demulsification, coagulation and curing process upon contacting with the cracks and/or leakage points, it can address leaks promptly as the leaks occur and does not work unless there is a leak, does not use a salt as the demulsifier, thereby avoiding the adverse effect on the properties of lost circulation control material formed after curing of the polymer latex, can more desirably meet the lost circulation control requirements of drilling and completion wells for deeply penetrating into cracks, and is capable of plugging the lost circulation of different dimensions.

In order to achieve the above objects, the first aspect of the present disclosure provides a plugging agent composition comprising polymer latex and a stabilizer, wherein the stabilizer has a cross-linkable group and/or a couplable group; the cross-linkable group and/or the couplable group in the stabilizer are/is cross-linked or coupled in the presence of a crack and/or a leakage point so that the polymer latex is coagulated and cured.

The second aspect of the present disclosure provides a use of the plugging agent composition according to the first aspect in lost circulation control of a hydrocarbon reservoir.

The third aspect of the present disclosure provides a hydrocarbon reservoir plugging method comprising the following steps: injecting the plugging agent composition according to the first aspect into a hydrocarbon reservoir formation, the composition flows into a crack and/or a leakage point of the hydrocarbon reservoir formation during the injection process, and is coagulated and cured at the crack and/or leakage point to form a cured product capable of withstanding a pressure of not less than 5 MPa at a temperature of 100° C.

Due to the aforementioned technical scheme, the present disclosure has the following favorable effects:
(1) The plugging agent composition provided by the present disclosure is a smart pressure-sensitive lost circulation control material, wherein the stabilizer has a cross-linkable group and/or a couplable group, the plugging agent composition can maintain a flowing state in the absence of a crack and/or leakage point, and activate the plugging process under the action of pressure difference and filtration loss effects when encountering the cracks and/or leakage points, can achieve an intelligent plugging which addresses leaks promptly as the leaks occur and does not work unless there is a leak.
(2) The plugging agent composition provided by the present disclosure adopts a brand-new demulsification mechanism, which comprises a stabilizer having a dual function of “stabilization” or “demulsification”, the stabilizer enables the polymer latex in the composition to maintain stability and fluidity under the ordinary state (there is not crack and/or leakage point), the stabilizer fails under the actions of pressure difference and filtration loss, so that the polymer latex destabilizes and demulsifies, thereby implementing the coagulating, curing, and plugging process, and avoiding the defect in the prior art that the plugging agent uses a salt to demulsify, the residual salt cations affect the properties of the rubber lost circulation control material formed after curing of the latex; in addition, the cross-linkable group and/or the couplable group contained in the stabilizer has a gain effect on the rubber lost circulation control materials formed after curing, in terms of viscous force, mechanical strength, and other aspects, resulting in better plugging effect. The cured product of the plugging agent composition provided by the present disclosure is capable of withstanding a pressure of not less than 5 MPa at a temperature of 100° C.
(3) The present disclosure provides a plugging agent composition that is capable of plugging cracks or leakage points with various sizes from nano-micron to millimeter (20 nm-1 mm) at a temperature of 100° C., thereby providing the lost circulation control field of drilling and completion well with a lost circulation control material having stronger adaptability to the size of cracks to be plugged. Under the circumstance that the plugging agent composition provided by the present disclosure comprises a bridging material, the plugging agent composition exhibits excellent plugging effect for cracks having a maximum width of 2 mm, in particular, when the plugging agent composition is used for plugging cracks having a width of 2 mm during the plugging property test, the cured product after the plugging process is capable of withstanding a pressure of 12 MPa at a temperature of 120° C.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

The first aspect of the present disclosure provides a plugging agent composition comprising polymer latex and a stabilizer, wherein the stabilizer has a cross-linkable group and/or a couplable group; the cross-linkable group and/or the couplable group in the stabilizer are/is cross-linked or coupled in the presence of a crack and/or a leakage point so that the polymer latex is condensed and cured. According to the present disclosure, the ingredients of the plugging agent composition are flowable after the mixing process, wherein the stabilizer is capable of implementing the functions of “stabilization” or “demulsification” for polymer latex under different circumstances, in particular, the stabilizer is capable of maintaining the stable existence of the polymer latex in the absence of a crack and/or leakage point and coagulating and curing the polymer latex in the presence of a crack and/or leakage point. In the absence of a crack and/or leakage point, the “stable existence” refers to that the latex particles in the polymer latex are uniformly dispersed in the polymer latex liquid system under the action of influences such as electrostatic force, Van der Waals force, and capillary force (The polymer latex in the “stable existence” state, although the latex particles contained therein precipitate by gravity factor after the long-term standing still, the latex particles do not exhibit an agglomeration phenomenon, and can be easily returned to the uniformly dispersed state after a simple stirring process), so that the polymer latex maintains the stable colloid lotion state and retains a desirable flowability; in the case of encountering with cracks and/or leakage points, there is a pressure difference at the cracks and/or leakage points, the pressure difference and the filtration loss effect will cause the stabilizer to dehydrate and cross-link (or couple), the cross-linked (or coupled) stabilizer gradually lost its stabilizing effect on the polymer latex, such that the polymer latex destabilizes and subjects to a phase transition (i.e., demulsification, coagulating and curing). Compared to the prior art the plugging agent adopts salt to facilitate demulsification and curing of latex, the present disclosure uses a completely different demulsification mode, the composition comprises a stabilizer having a dual function of “stabilization” or “demulsification”, which can cause the polymer latex to maintain stable existence or demulsify under different circumstance, thereby implementing an intelligent lost circulation control which can address leaks promptly as the leaks occur and does not work unless there is a leak, and avoiding the adverse influence by the residual metal cations caused by the mode of demulsification with salt on the properties of rubber lost circulation control material formed after curing of the latex, providing a new idea and method to the lost circulation control in the well drilling field, and safeguarding the secured and efficient operations.

In the present disclosure, the pressure difference refers to the difference between the inside pressure and the outside pressure at the cracks and/or leakage points of the borehole wall, i.e., the pressure difference between the operating fluid pressure in the wellbore (inside pressure) and the pore pressure (outside pressure) in the formation where the cracks and/or leakage points reside. For example, during the operations of drilling and completion well, there is a positive pressure difference in the lost circulation formation, i.e., the operating fluid pressure in the wellbore is higher than the pore pressure in the formation.

In the present disclosure, just as the name implies, crack refers to an elongated shape opening in the borehole wall, and leakage point refers to a hole-like opening having a smaller length/width ratio than the crack, both of which may have a regular or irregular shape. Either crack or leakage point can generate a difference between the inside pressure and the outside pressure. The terms “crack and/or leakage point” in the present disclosure serve to illustrate that the plugging agent composition of the present disclosure can be used for plugging borehole wall openings of various shapes.

According to the present disclosure, the cured product formed by curing the polymer latex has an excellent plugging effect on cracks and/or leakage points. Preferably, the cured product is capable of withstanding a pressure of not less than 5 MPa, preferably a pressure within the range of 5-12 MPa at a temperature of 100° C.

In the present disclosure, the plugging performance test is implemented using the Fann permeability plugging apparatus (PPA type) manufactured in the United States of America (USA).

According to the present disclosure, the concentration of metal cations in the composition is below 0.1 wt %, such that the cured product formed from curing of the composition has better mechanical strength and corrosion resistance, thereby obtaining a better plugging effect.

In the present disclosure, the metal cations include but are not limited to, at least one of Na⁺, K⁺, Mg²⁺, Ca²⁺, Zn²⁺, and Cu²⁺.

According to the present disclosure, furthermore, the composition does not contain a metal cation demulsifier, particularly does not contain a demulsifier having divalent and above metal cations. In the present disclosure, the metal cation demulsifier refers to an agent capable of breaking charge balance using the metal cation groups contained therein, thereby resulting in demulsification of the polymer latex, including but not limited to Zn(OAc)₂, Cu(OAc)₂, CuSO₄, CaCl₂), MgSO₄, NaCl, Na₂SO₃, Na₂SO₄, CH₃COONa, KH₂PO₄, and the like.

According to the present disclosure, the weight ratio of polymer latex:stabilizer in the composition is 1:(0.0001-0.2), preferably 1:(0.001-0.1). The weight ratio facilitates the stabilizer to perform better “stabilization” or “demulsification” effect on the polymer latex according to the different conditions.

According to the present disclosure, the stabilizer in the composition has a cross-linkable group and/or a couplable group, while the latex stabilizers of the prior art (e.g., casein, gelatine, sulphate salts, etc.) do not have a cross-linkable group and/or a couplable group. The cross-linkable group and/or couplable group is a key factor for the stabilizer that has the dual function of “stabilization” or “demulsification”. Under normal conditions (there are no cracks and/or leakage points), the stabilizer can adsorb or graft onto the latex particles in the polymer latex and form a hydrated layer, such that the polymer latex exists stably by the combined action of electrostatic force, steric hindrance, and hydrated layer; in the event of pressure differences and lost circulation encountered at crack and/or leakage points, the latex particles remove the hydrated layer to expose the stabilizer, the cross-linkable group and/or couplable group is cross-linked (or coupled), chemically or physically, in such a way that the cross-linked stabilizer is deactivated and the polymer latex is demulsified. By controlling the content of the cross-linkable group and/or couplable group in the stabilizer, the cross-linking and demulsification process can be carried out gradually, such that the composition is initially coagulated and thickened, but not cured immediately (i.e., the plugging process is controlled and divided into two stages of thickening and curing performed in sequence), giving the composition (lost circulation control material fluid) an opportunity to further deep into cracks and/or leakage points, such that the composition is further cured during the process of entering cracks and/or leakage points to achieve deep plugging, instead of the surface or shallow plugging, avoiding the “door-sealing” type plugging resulting from the rapid curing, the sealing effect is better, and is more adaptive to the requirement for lost circulation control in drilling and completion wells. Preferably, the content of a cross-linkable group and/or a couplable group in the stabilizer is within the range of 0.001-20 wt %, preferably within the range of 0.01-8 wt %, based on the total weight of the stabilizer. According to the present disclosure, the cross-linkable group and/or couplable group has a gain effect on the rubber lost circulation control materials formed after curing, in terms of the viscous force, mechanical strength, and other aspects, resulting in a better plugging effect. According to the present disclosure, the cross-linkable group and/or couplable group refers to the group capable of undergoing cross-linking or coupling reaction to form a larger molecule under the specific conditions herein, given that both the cross-linking reaction and the coupling reaction can achieve the object of the invention, the present disclosure does not especially distinguish the cross-linking reaction from the coupling reactions. In the present disclosure, the cross-linkable group and/or couplable group may be at least one selected from unsaturated double bonds or triple bonds, epoxy groups, thiol groups, amino groups, ureido groups, acyloxy groups, monoalkoxyphenyl groups, benzyl groups, halo groups, and siloxy groups. According to a preferred embodiment of the present disclosure, the cross-linkable group and/or the couplable group is siloxy. In the examples of the present disclosure, the content of siloxy is taken as the content of a cross-linkable group and/or a couplable group.

In the present disclosure, the content of the cross-linkable group and/or couplable group can be calculated by means of the infrared spectroscopic analysis combined with the nuclear magnetic resonance spectrogram, specifically, initially subjecting the composition to a gel chromatography separation, separating out the stabilizer, and determining the kind of a cross-linkable group and/or a couplable group in the stabilizer by using an infrared spectroscopic analysis, and then determining the content of the cross-linkable group and/or couplable group through the quantitative nuclear magnetic resonance internal standard method, specifically, subjecting the stabilizer obtained by the gel chromatography separation to a sampling and weighing process, mixing the weighed stabilizer sample and an internal standard into a solution (if hydrogen spectra are tested, an internal standard for hydrogen spectroscopy internal standard method is adopted; if silicon spectra are tested, an internal standard for silicon spectroscopy internal standard method is adopted), and subjecting the solution to a nuclear magnetic resonance test (taking a silicon nuclear magnetic resonance when the cross-linkable group and/or couplable group is siloxy), calculating the amount of the cross-linkable group and/or couplable group, based on the peak area of characteristic peaks of the cross-linkable group and/or couplable group in the stabilizer measured by nuclear magnetic resonance and the peak area of the characteristic peaks of the internal standard, further dividing it with the amount of the weighed stabilizer sample, so that the content of the cross-linkable group and/or couplable group in the stabilizer is obtained. Further, in the case of known raw materials, the content of the cross-linkable group and/or couplable group can also be calculated based on the feeding amount of raw materials.

According to the present disclosure, the stabilizer is a polymer and contains the cross-linkable group and/or couplable group, on this basis, the stabilizer further comprises at least one of the groups

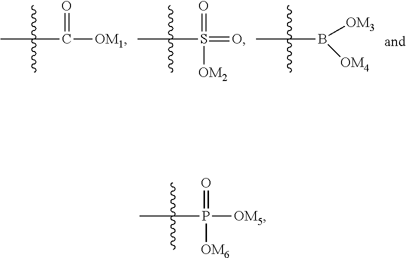

preferably at least one of the groups

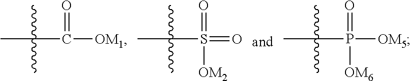

wherein M₁, M₂, M₃, M₄, M₅, and M₆ are each independently selected from H⁺, Na⁺, K⁺, or NH₄⁺.

According to the present disclosure, in the above structural formula of the groups, [symbol] represents the attachment positions of the group to the main chain or side chain of the polymer.

According to the present disclosure, the stabilizer has a weight average molecular weight within the range of 10,000-100,000 g/mol, preferably within the range of 20,000-50,000 g/mol.

In the present disclosure, the weight average molecular weight of the polymer is determined by gel chromatography.

According to the present disclosure, the stabilizer preferably has a structural unit A represented by formula (1), a structural unit B represented by formula (2) or formula (3), a structural unit C represented by formula (4) or formula (5);

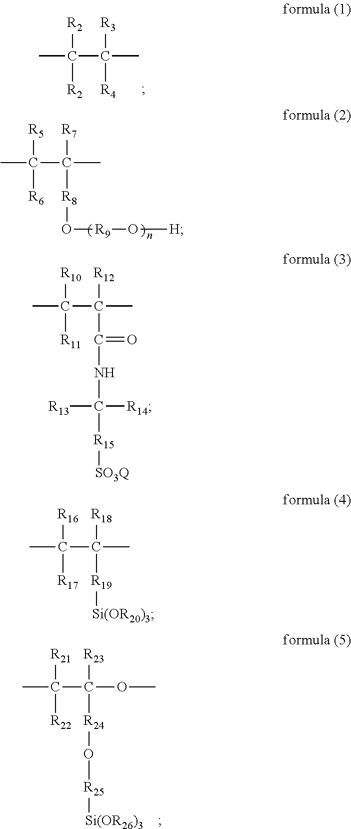

wherein R₁, R₂, R₃, and R₄ in formula (1) are each independently selected from —H, —CH₃, —COOM¹, —SO₃M², —CH₂COOM³, —CH₂SO₃M⁴,

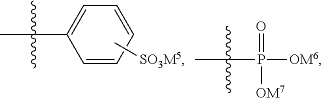

or —CONHC(CH₃)₂CH₂SO₃M⁸, R₁, R₂, R₃, and R₄ are not selected from —H or —CH₃ simultaneously; wherein M¹, M², M³, M⁴, M⁵, M⁶, M⁷, and M⁸ are each independently selected from H⁺, K⁺, Na⁺, or NH₄⁺;
R₅, R₆, and R₇ in formula (2) are each independently selected from —H or C₁-C₁₈ alkyl; R₈ is selected from C₁-C₃ alkylene; and R₉ is selected from C₁-C₃ alkylene;
R₁₀, R₁₁, R₁₂, R₁₃, and R₁₄ in formula (3) are each independently selected from —H, or C₁-C₄ alkyl;
R₁₅ is selected from C₁-C₄ alkylene; Q is selected from H⁺, K⁺, Na⁺, or NH₄⁺;
R₁₆, R₁₇, and R₁₈ in formula (4) are each independently selected from —H, or C₁-C₁₈ alkyl; R₁₉ is selected from a chemical bond, C₁-C₁₈ alkylene, or —COOCH₂CH₂CH₂—; R₂₀ is selected from C₁-C₂ alkyl, —CH₂OCH₃, or —CH₂CH₂OCH₃;
R₂₁, R₂₂, and R₂₃ in formula (5) are each independently selected from —H, or C₁-C₁₈ alkyl; R₂₄ is selected from C₁-C₁₈ alkylene; R₂₅ is selected from C₁-C₃ alkylene; and R₂₆ is selected from C₁-C₂ alkyl;
the molar ratio of structural unit A:structural unit B:structural unit C is within the range of (1-2,000):100:(0.01-400), preferably within the range of (50-1,500):100:(0.05-100), further preferably within the range of (200-1,200):100:(0.1-30).

According to a particularly preferred embodiment of the present disclosure, the stabilizer is a copolymer-I having a structural unit A represented by formula (1), a structural unit B represented by formula (2), a structural unit C represented by formula (4) or formula (5);
wherein R₁, R₂, R₃, and R₄ in formula (1) are each independently selected from —H, —CH₃, —COOM¹, —SO₃M², —CH₂COOM³, —CH₂SO₃M⁴,

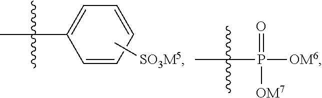

or —CONHC(CH₃)₂CH₂SO₃M⁸, R₁, R₂, R₃, and R₄ are not selected from —H or —CH₃ simultaneously; wherein M¹, M², M³, M⁴, M⁵, M⁶, M⁷, and M⁸ are each independently selected from H⁺, K⁺, Na⁺, or NH₄⁺;
R₅, R₆, and R₇ in formula (2) are each independently selected from —H or C₁-C₂ alkyl; R₈ is selected from C₁-C₃ alkylene; and R₉ is selected from C₁-C₂ alkylene;
R₁₆, R₁₇, and R₁₈ in formula (4) are each independently selected from —H, or C₁-C₂ alkyl; R₁₉ is selected from a chemical bond, or —COOCH₂CH₂CH₂—; R₂₀ is selected from C₁-C₂ alkyl, —CH₂OCH₃, or —CH₂CH₂OCH₃;
R₂₁, R₂₂, and R₂₃ in formula (5) are each independently selected from —H, or C₁-C₂ alkyl; R₂₄ is selected from C₁-C₂ alkylene; R₂₅ is selected from C₁-C₃ alkylene; and R₂₆ is selected from C₁-C₂ alkyl;

In the copolymer-I, the molar ratio of structural unit A:structural unit B:structural unit C is within the range of (1-2,000):100:(0.01-400), preferably within the range of (50-1,500):100:(0.05-100), further preferably within the range of (200-1,200):100:(0.1-30).

According to the present disclosure, the preparation method of the copolymer-I comprises the following steps: in the presence of an initiator and a chain transfer agent, carrying out a polymerization reaction on an unsaturated polyether monomer, an unsaturated acid or a salt thereof or an anhydride thereof, and a silane coupling agent to produce the copolymer-I.

According to an embodiment of the present disclosure, in the preparation method of the copolymer-I, the feeding amount of raw materials satisfies the following relationship: the molar ratio of unsaturated acid or salt thereof or anhydride thereof:unsaturated polyether monomer:silane coupling agent is (1-2,000):100:(0.01-400); the molar ratio of initiator:(unsaturated acid or salt thereof or anhydride thereof+unsaturated polyether monomer) is (0.01-5):100, wherein the initiator is calculated in terms of oxidizing agent when the system is a redox initiation system; the molar ratio of chain transfer agent:(unsaturated acid or salt thereof or anhydride thereof+unsaturated polyether monomer) is (0.01-10):100.

According to the present disclosure, in the preparation method of the copolymer-I, the unsaturated polyether monomer may be at least one selected from the group consisting of methallyl alcohol polyoxyethylene ether, methallyl alcohol polyoxypropylene ether, isopentenol polyoxyethylene ether, and isobutenol polyoxyethylene ether, preferably isopentenol polyoxyethylene ether.

According to the present disclosure, in the preparation method of the copolymer-I, unsaturated acid or a salt thereof or anhydride thereof refers to an unsaturated acid, or a sodium salt, a potassium salt, an ammonium salt of an unsaturated acid, or an anhydride of an unsaturated acid. Preferably, the unsaturated acid may be at least one selected from the group consisting of acrylic acid, methacrylic acid, vinylsulfonic acid, vinylphosphoric acid, maleic acid, itaconic acid, fumaric acid, 2-acrylamido-2-methylpropane sulfonic acid, styrenesulfonic acid, and propenylsulfonic acid, preferably acrylic acid and/or itaconic acid.

According to the present disclosure, in the preparation method of the copolymer-I, the silane coupling agent may be at least one selected from the group consisting of vinyltriacetoxysilane, vinyltriethoxysilane (A-151), vinyltrimethoxysilane (A-171), vinyltri(β-methoxyethoxy) silane (A-172), γ-aminopropyltriethoxysilane (KH-550), γ-glycidoxypropyltrimethoxysilane (KH-560), vinyloctadecyltrimethoxysilane, and γ-methacryloxypropyltrimethoxysilane (KH-570), preferably γ-methacryloxypropyltrimethoxysilane.

According to the present disclosure, the initiator is preferably a redox type initiator comprising an oxidizing agent and a reducing agent.

In the preparation method of the copolymer-I, the oxidizing agent in the initiator can be at least one selected from the group consisting of hydrogen peroxide, peroxyacetic acid, ammonium persulfate, sodium persulfate, and potassium persulfate, preferably hydrogen peroxide. The concentration of the hydrogen peroxide is preferably within the range of 25-30 wt %.

In the preparation method of the copolymer-I, the reducing agent in the initiator may be at least one selected from the group consisting of ascorbic acid, sodium formaldehyde sulfoxylate, and sodium hydrosulfite, and preferably ascorbic acid.

According to the present disclosure, in the preparation method of the copolymer-I, the chain transfer agent can be selected from thioglycollic acid and/or 3-mercaptopropionic acid, preferably 3-mercaptopropionic acid.

According to the present disclosure, in the preparation method of the copolymer-I, the unsaturated polyether monomer, the unsaturated acid or salt thereof or anhydride thereof, the oxidizing agent, the reducing agent, and the chain transfer agent are preferably fed in the form of an aqueous solution. Preferably, the concentration of the unsaturated polyether monomer in an aqueous solution containing the unsaturated polyether monomer is 20-90 wt %; the concentration of the unsaturated acid or salt thereof or anhydride thereof in an aqueous solution containing the unsaturated acid or salt thereof or anhydride thereof is 20-80 wt %; the concentration of the oxidizing agent in an aqueous solution containing the oxidizing agent is 9-40 wt %; in an aqueous solution containing the reducing agent and the chain transfer agent, the concentration of the reducing agent is 2-10 wt %, and the concentration of the chain transfer agent is 2-6 wt %.

According to a preferred embodiment of the present disclosure, the preparation method of the copolymer-I comprises the following steps:
(1) Heating an aqueous solution containing the unsaturated polyether monomer to the temperature of 50-70° C., maintaining the temperature for 0.2-1 h, and adding an aqueous solution containing the oxidizing agent;
(2) Then adding an aqueous solution containing the unsaturated acid or salt thereof or anhydride thereof, a silane coupling agent, and an aqueous solution containing the reducing agent and the chain transfer agent simultaneously; wherein the feeding time of the aqueous solution containing the unsaturated acid or salt thereof or anhydride thereof, and the silane coupling agent is 2-4 h, and the feeding time of the aqueous solution containing the reducing agent and the chain transfer agent is 2.5-4.5 h;
(3) After the feeding process of all the raw materials in step (2) is completed, continuously preserving the heat for 0.5-1 h to prepare the copolymer-I.

According to another particularly preferred embodiment of the present disclosure, the stabilizer is copolymer-II having a structural unit A represented by formula (1), a structural unit B represented by formula (3), a structural unit C represented by formula (4) or formula (5);
where R₁, R₂, R₃, and R₄ in formula (1) are each independently selected from —H, —CH₃, —COOM¹, —SO₃M², —CH₂COOM³, —CH₂SO₃M⁴,

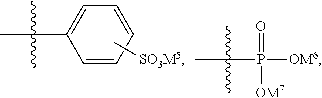

or —CONHC(CH₃)₂CH₂SO₃M⁸, R₁, R₂, R₃, and R₄ are not selected from —H or —CH₃ simultaneously;
wherein M¹, M², M³, M⁴, M⁵, M⁶, M⁷, and M⁸ are each independently selected from H⁺, K⁺, Na⁺, or NH₄⁺;
R₁₀, R₁₁, R₁₂, R₁₃, and R₁₄ in formula (3) are each independently selected from —H, or C₁-C₂ alkyl;
R₁₅ is selected from C₁-C₂ alkylene; Q is selected from H⁺, K⁺, Na⁺, or NH₄⁺;
R₁₆, R₁₇, and R₁₈ in formula (4) are each independently selected from —H, or C₁-C₂ alkyl; R₁₉ is selected from a chemical bond, or —COOCH₂CH₂CH₂—; R₂₀ is selected from C₁-C₂ alkyl, —CH₂OCH₃, or —CH₂CH₂OCH₃;
R₂₁, R₂₂, and R₂₃ in formula (5) are each independently selected from —H, or C₁-C₂ alkyl; R₂₄ is selected from C₁-C₂ alkylene; R₂₅ is selected from C₁-C₃ alkylene; and R₂₆ is selected from C₁-C₂ alkyl;

In the copolymer-II, the molar ratio of structural unit A:structural unit B:structural unit C is within the range of (1-2,000):100:(1-100), preferably within the range of (50-1,500):100:(5-50), further preferably within the range of (200-800):100:(10-30).

According to the present disclosure, the preparation method of the copolymer-II comprises the following steps: in the presence of an initiator, subjecting 2-acrylamido-2-methylpropane sulfonic acid, an unsaturated acid or a salt thereof or an anhydride thereof, and a silane coupling agent to a polymerization reaction to produce the copolymer-II.

According to the present disclosure, in the preparation method of the copolymer-II, the feeding amount of raw materials satisfies the following relationship: the molar ratio of the unsaturated acid or salt thereof or anhydride thereof:2-acrylamido-2-methylpropane sulfonic acid:silane coupling agent is (1-2,000):100:(0.01-400); the molar ratio of the initiator:(unsaturated acid or salt thereof or anhydride thereof +2-acrylamido-2-methylpropane sulfonic acid) is (0.01-10):100. According to the present disclosure, the definitions of the unsaturated acid or a salt thereof or anhydride thereof, and the silane coupling agent in the preparation method of the copolymer-II are identical to those in the preparation method of the copolymer-I, respectively.

According to the present disclosure, in the preparation method of the copolymer-II, the initiator may be at least one selected from the group consisting of a peroxide type initiator, an azo type initiator, and a redox type initiator, preferably at least one of a persulfate initiator, a persulfate-sulfite system initiator, and a hydrogen peroxide-ascorbic acid system initiator. The initiator is preferably fed in the form of a solution, and the concentration of the initiator in the solution containing the initiator is preferably within the range of 5-20 wt %.

According to a preferred embodiment of the present disclosure, the preparation method of the copolymer-II comprises the following steps:

Mixing 2-acrylamido-2-methylpropane sulfonic acid with water in a weight ratio of 1:(2-6) to obtain an aqueous 2-acrylamido-2-methylpropane sulfonic acid solution; adjusting pH of the aqueous 2-acrylamido-2-methylpropane sulfonic acid solution to a range of 9-12, heating the aqueous solution to the temperature of 30-70° C., then adding the unsaturated acid or salt thereof or anhydride thereof, an initiator solution, and the silane coupling agent, further raising the temperature to 50-120° C. for carrying out a reaction for 2-6 h, the copolymer-II is prepared.

According to the present disclosure, the polymer latex in the composition may be at least one selected from the group consisting of nitrile latex, styrene-butadiene latex, styrene-propylene latex, butyl latex, pure propylene latex, neoprene latex, natural rubber latex, fluoro rubber latex, polybutadiene latex, ethylene propylene diene monomer (EPDM) latex, silicone rubber latex, and polyacrylate latex, preferably nitrile latex and/or styrene-propylene latex.

According to the present disclosure, the polymer latex comprises latex particles having a particle size (i.e. particle diameter) of 20-300 nm and/or latex particles having a particle size of 300 nm-2 mm. In the present disclosure, the polymer latex further comprises a base latex and/or a latex pre-polymer, wherein the base latex refers to an emulsion formed by dispersing polymer particles in water, preferably the particle size of the latex particles in the base latex is within the range of 20-300 nm; the latex pre-polymer refers to an emulsion containing latex particles having a larger particle size and being formed by aggregating the latex particles of the base latex, the particle size of the latex particles in the latex pre-polymer is preferably within the range of 300 nm-2 mm.

According to the present disclosure, the particle size of the latex particles is measured by a laser particle size analyzer (manufactured by Malvern Instruments Limited in the UK, model Mastersizer 3000).

In the present disclosure, the particle size range of the latex particles refers to both the maximum and minimum particle size of all the latex particles in polymer latex fall within the range. For example, the particle size of 20-300 nm of the latex particles means that both the maximum and minimum particle size of all the latex particles in polymer latex fall within the range of 20-300 nm. For example, a minimum minimum particle size of 20 nm and a maximum particle size of 300 nm among all the latex particles in polymer latex; in another example, a minimum particle size of 20 nm and a maximum particle size of 50 nm among all the latex particles in polymer latex; in another example, a minimum particle size of 100 nm and a maximum particle size of 150 nm among all the latex particles in polymer latex; in a further example, a minimum particle size of 200 nm and a maximum particle size of 300 nm among all the latex particles in polymer latex; each of the above circumstances falls into the particle size range of the latex in the present disclosure.

According to the present disclosure, when the polymer latex in the composition is completely composed of the base latex, the composition may have an excellent plugging effect on the nano-micron-scale cracks and/or leakage points.

According to the present disclosure, when a portion of polymer latex in the composition is latex pre-polymer, the large size latex particles contained in the latex pre-polymer can act like a “crystal seed” and “bridge” to promote better coagulating and curing of the latex particles in the base latex to form a solid rubber plugging material having viscous force, resulting in the plugging effect on the nano-micron-scale cracks and/or leakage points with a larger size. Further, when the polymer latex in the composition is completely composed of latex pre-polymer, the composition can produce the plugging effect on cracks and/or leakage points with large sizes (close to or up to millimeters). In the present disclosure, the latex pre-polymer may be obtained with a conventional method, for example, the latex pre-polymer may be prepared by co-reacting an agglomeration agent with the base latex. In a preferred embodiment of the present disclosure, the method for preparing the latex pre-polymer comprises the following steps: adding the agglomeration agent to the base latex and sufficiently blending the materials, adjusting the pH of the system with sodium hydroxide to a range of 9-10, then carrying out a reaction under stirring conditions to obtain the latex pre-polymer, wherein the weight ratio of agglomeration agent to base latex is (0.5-3):100, and the reacting conditions comprise a temperature of 30-50° C. for a time of 0.5-2 hours.

In the present disclosure, the agglomeration agent is defined in the relatively broad range, it may be self-made through the conventional method or may be commercially available products including, but not limited to ethanol, polyurethane emulsion, polyethyleneimines, polyetheramines, and the like. In a preferred embodiment of the present disclosure, the agglomeration agent may be prepared with the following method:
Reacting an olefinic monomer with an α,β-unsaturated carboxylic acid in the presence of an initiator, an emulsifier, and water to produce an agglomeration agent;
Preferably, wherein the olefinic monomer is butyl acrylate; the α, β-unsaturated carboxylic acid is methacrylic acid; the initiator is sodium persulfate, and the emulsifier is sodium dodecylbenzenesulfonate;
Preferably, the mass ratio of the α, β-unsaturated carboxylic acid to the olefinic monomer is (0.03-0.45):1, more preferably (0.1-0.25):1;
Preferably, the reaction conditions comprise a temperature of 50-90° C. for a time of 4-9 hours.

According to the present disclosure, in the polymer latex, the polymer species contained in the base latex and the latex pre-polymer may be the same (for example, the base latex is styrene-propylene latex and the latex pre-polymer is styrene-propylene latex pre-polymer) or different (for instance, the base latex is styrene-propylene latex, while the latex pre-polymer is ethylene propylene diene monomer latex pre-polymer), preferably, the polymer species contained in the base latex and the latex pre-polymer are the same.

According to the present disclosure, the composition further comprises a surfactant. Preferably, the surfactant is selected from anionic surfactants and/or non-ionic surfactants.

In the present disclosure, the anionic surfactant is at least one selected from the group consisting of polyacrylamide, alkyl benzene sulfonate, ammonium alkylphenol polyoxyethylene ether sulphate, fatty acid alkyl sulfonate ester, alkyl sulfonic ester salt, alkyl sulfonate, polysiloxane, α-alkenyl sulphonate, and alkyl alcohol amide, preferably ammonium alkylphenol polyoxyethylene ether sulphate.

In the present disclosure, the non-ionic surfactant is at least one selected from the group consisting of alkylphenol polyoxyethylene ether, polyol mono fatty acid ester, alkylamine oxide, and N-alkyl pyrrolidone, preferably alkylphenol polyoxyethylene ether.

According to the present disclosure, the weight ratio of polymer latex:surfactant in the composition is 1:(0.0001-0.2), preferably 1:(0.001-0.1).

According to the present disclosure, the composition may further contain a bridging material, such that the cracks with larger dimensions can be plugged. In the case that the plugging agent composition comprises a bridging material, it can exert a desirable plugging effect on cracks having a maximum width of 2 mm. When the plugging agent composition is used for plugging cracks having a width of 2 mm during the plugging property test (using a permeability plugging apparatus, PPA type), the cured product after the plugging process is capable of withstanding a pressure of 12 MPa at a temperature of 120° C.

According to the present disclosure, the bridging material is preferably at least one selected from the group consisting of walnut shell, elastic particles, and fibrous material.

According to the present disclosure, it is preferred that the walnut shell has a particle size (i.e., a particle diameter) within the range of 150-450 μm; the elastic particles have a particle size within the range of 450-850 μm.

In the present disclosure, the particle size of the bridging material is measured with a sieving method.

In the present disclosure, the particle size range of the walnut shell and the particle size of the elastomeric particles described above refers to both the maximum and minimum particle size of all the particles in the walnut shell or the elastomeric particles fall within the range. For example, the walnut shell has a particle size within the range of 150-450 μm refers to that both the maximum and minimum particle sizes of all the particles in the walnut shell fall within the range of 150-450 μm. For example, a minimum particle size of 150 μm and a maximum particle size of 450 μm among all the particles in the walnut shell; in another example, a minimum particle size of 150 μm and a maximum particle size of 200 μm among all the particles in the walnut shell; in another example, a minimum particle size of 250 μm and a maximum particle size of 300 μm among all the particles in the walnut; in a further example, a minimum particle size of 350 μm and a maximum particle size of 450 μm among all the particles in the walnut; each of the above circumstances falls into the particle size range of the walnut shell in the present disclosure.

According to the present disclosure, it is preferred that the fibrous material has a fiber length within the range of 5-40 mm. In the present disclosure, the fiber length can be measured by an optical microscope.

In the present disclosure, preferably, the elastic particles may be selected from elastic graphite and/or elastic rubber; the fibrous material may be at least one selected from the group consisting of natural fiber, carbon fiber, ceramic fiber, steel fiber, polyester fiber, polyamide fiber, and polypropylene fiber.

According to the present disclosure, the weight ratio of polymer latex:bridging material in the composition is 1:(0.001-1), further preferably 1:(0.01-0.2).

The plugging agent composition provided by the present disclosure can be obtained by mixing the above-mentioned components.

In the present disclosure, the components of the plugging agent composition and optionally water are mixed to form a plugging agent suspension, which is used in a suspension form for performing a plugging operation. In the case that the plugging agent composition and water are formulated into a plugging agent suspension, water is preferably used in a feeding amount to formulate the plugging agent suspension such that the solid phase content of the plugging agent suspension is within the range of 0.1-85 wt. %.

According to a preferred embodiment of the present disclosure, the process for formulating the plugging agent suspension comprises the following steps:
In the case of polymer latex having both a base latex and a latex pre-polymer, subjecting optional water to a first mixing with a base latex and a surfactant in the plugging agent composition to obtain a first mixed product; then subjecting the first mixed product to a second mixing with a stabilizer in the plugging agent composition to obtain a second mixed product; finally subjecting the second mixed product to a third mixing with a latex pre-polymer in the plugging agent composition to produce the plugging agent suspension;
In the case that the polymer latex is completely composed of a base latex, subjecting optional water to a first mixing with a base latex and a surfactant in the plugging agent composition to obtain a first mixed product; then subjecting the first mixed product to a second mixing with a stabilizer in the plugging agent composition to produce the plugging agent suspension;
In the case that the polymer latex is completely composed of a latex pre-polymer, subjecting an optional water to a first mixing with a latex pre-polymer and a surfactant in the plugging agent composition to obtain a first mixed product; then subjecting the first mixed product to a second mixing with a stabilizer in the plugging agent composition to produce the plugging agent suspension. The second aspect of the present disclosure provides a use of the plugging agent composition according to the first aspect in lost circulation control of a hydrocarbon reservoir.

The plugging agent composition provided by the present disclosure has an intelligent plugging efficacy of addressing leaks promptly as the leaks occur and does not work unless there is a leak, is capable of deeply permeating into cracks and/or leakage points for lost circulation control, solves the deficiency in plugging effect of the “door-sealing” plugging, and adopts a demulsification mode different from the salting-out process, such that the properties of cured product are immune to an influence of the metal cations, has the advantages of desirable sealing, high strength, and strong corrosion resistance, can be used for high permeability lost circulation formation, lost circulation formation with nano-micron to millimeter scale cracks, high-pressure gas reservoir with pressure-sensitive cracks and pores, air leakage of the gas storage, and the like, achieves lost circulation control of cracks, or sealing cracks for plugging the gas leakage, and can address leaks promptly as the leaks occur for induced and random lost circulation at multiple points re-occur at the plugged formation.

The third aspect of the present disclosure provides a hydrocarbon reservoir plugging method comprising the following steps: injecting the plugging agent composition according to the first aspect into a hydrocarbon reservoir formation, the composition flows into a crack and/or a leakage point of the hydrocarbon reservoir formation during the injection process, and is coagulated and cured at the crack and/or leakage point to form a cured product capable of withstanding a pressure of not less than 5 MPa at a temperature of 100° C.

According to the present disclosure, the temperature of the hydrocarbon reservoir formation is preferably within the range of 30-120° C.

According to the present disclosure, preferably, the crack has a width within the range of 20 nm-2 mm; and the leakage point has a size within the range of 20 nm-300 nm.

In the present disclosure, the width of the crack refers to the maximum cross-sectional dimension of the crack. The size of the leakage point refers to the maximum cross-sectional dimension of the leakage point.

The hydrocarbon reservoir plugging method provided by the present disclosure uses the plugging agent composition of the present disclosure as a lost circulation control material, which is capable of achieving self-driven plugging, particularly suitable for lost circulation control of a scene having an uncertain leakage location, accommodating various operating environments from normal temperature and pressure to high-temperature and high-pressure, capable of plugging cracks and/or leakage points of various sizes from nano-micron to millimeter scale, the plugging effect is excellent, the plugging agent composition is coagulated and cured only at cracks and/or leakage points, and the plugging agent composition used for lost circulation control that has not reached crack and/or leakage points can maintain a flow state and be recycled, it has advantages in terms of plugging effects, applicable scenarios and construction costs compared to the existing plugging methods.

The present disclosure will be described in detail below with reference to examples. In the examples and comparative examples below, if the particular conditions are not indicated, the preparation method is implemented according to the conventional conditions or the conditions recommended by the manufacturer. If the manufactures of the reagents or instruments in use are not specified, both the reagents and the instruments are conventional commercially available products.

Agglomeration age-1:40 parts by weight of butyl acrylate, 0.02 part by weight of sodium persulfate, 2 parts by weight of sodium dodecylbenzenesulfonate were added to a reaction kettle, then stirred and heated to a temperature of 70° C.; a solution composed of 80 parts by weight of butyl acrylate, 30 parts by weight of methacrylic acid, 0.06 part by weight of sodium persulfate, and distilled water was dropwise added to the reaction kettle, and stirred for a time of 6 h, the agglomeration agent-1 was obtained.

Agglomeration agent-2: polyetheramine D-400, commercially available.

Base latex-1: carboxylated nitrile latex, commercially available, had a solid content of 45 wt %, wherein the latex particles had a particle size of 70-200 nm measured by a laser particle size analyzer (manufactured by the Malvern Instruments Limited in the UK, model Mastersizer 3000).

Latex pre-polymer-1: 3 parts by weight of the above-mentioned agglomeration agent-1 were added to 100 parts by weight of the base latex-1 under rapid stirring conditions of 300 rpm, the system pH was adjusted to 9 by using sodium hydroxide, stirring was carried out at 300 rpm after completion of the adding process, stirred and heated to 50° C., and carried out a reaction for the time of 2 h, a latex pre-polymer of carboxylated nitrile latex was produced. The particle size of the latex particles in the latex pre-polymer of carboxylated nitrile latex was within the range of 430-580 nm as measured by the laser particle size analyzer (manufactured by Malvern Instruments Limited in the UK, model Mastersizer 3000).

The base latex-2: styrene-propylene latex, commercially available, had a solid content of 45 wt %, wherein the latex particles had a particle size of 80-220 nm measured by a laser particle size analyzer (manufactured by the Malvern Instruments Limited in UK, model Mastersizer 3000).

Latex pre-polymer-2:3 parts by weight of the above-mentioned agglomeration agent-2 were added to 30 parts by weight of the base latex-2 under the stirring condition of 300 rpm, stirred and heated to 40° C., the reaction was performed for a time of 30 min, then subjected to standing still for 2 h; subsequently stirred at 150 rpm, slowly and dropwise added deionized water to reduce the solid content of the emulsion to 35 wt %, an OP-10 emulsifier was added at an amount of 1% of the total weight of the solid phase, and stirred at 300 rpm for 1 h, a latex pre-polymer of styrene-propylene latex was prepared. The particle size of the latex particles in the latex pre-polymer of the styrene-propylene latex was within the range of 315-460 nm as measured by the laser particle size analyzer (manufactured by Malvern Instruments Limited in the UK, model Mastersizer 3000).

### Preparation Example 1

100 kg of isopentenol polyoxyethylene ether (TPEG-2400) and 150 kg of deionized water were added to a reaction kettle, stirred and heated to 70° C., preserved the temperature for 1 h; 1.5 kg of hydrogen peroxide (with a concentration of 30 wt %) was added to 15 kg of deionized water, stirred uniformly and then added to the reaction kettle; 7.5 kg of ascorbic acid and 1 kg of 3-mercaptopropionic acid were added to 17 kg of deionized water to formulate a mixed aqueous solution of a reducing agent and a chain transfer agent; 40 kg of Acrylic Acid (AA) was added to 40 kg of deionized water to formulate an aqueous acrylic acid solution; the mixed aqueous solution of reducing agent and chain transfer agent above, 1 kg of silane coupling agent (KH-570), and the aqueous acrylic acid solution above were simultaneously and dropwise added to a round-bottom flask, a peristaltic pump was used for controlling that the aqueous acrylic acid solution and KH-570 were dropwise added in 4 h, and the mixed aqueous solution of reducing agent and chain transfer agent was dropwise added in 4.5 h, after completion of the dropwise adding process of all the materials, the heat preservation and stirring were continued for 0.5 h, subsequently cooled to room temperature, a stabilizer sample 1 (with a solid content of 40 wt %) was prepared;

The weight-average molecular weight of the stabilizer sample 1 was measured to be 35,000 g/mol by gel chromatography;

In the stabilizer sample 1, the molar ratio of structural unit

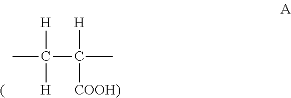

structural unit

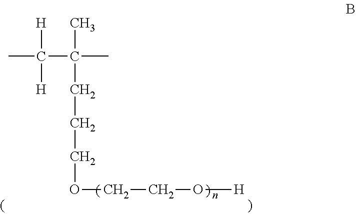

structural unit

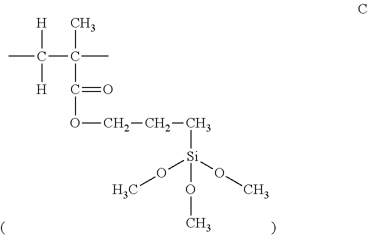

was 800:100:10; based on the total weight of the stabilizer sample 1, wherein the content of siloxy (i.e., cross-linkable group) was 0.37 wt % by calculation based on the feeding amount of raw materials.

### Preparation Example 2

100 kg of isopentenol polyoxyethylene ether (TPEG-2400) and 150 kg of deionized water were added to a reaction kettle, stirred and heated to 70° C., preserved the temperature for 1 h; 1.5 kg of hydrogen peroxide (with a concentration of 30 wt %) was added to 15 kg of deionized water, stirred uniformly and then added to the reaction kettle; 75 kg of ascorbic acid and 10 kg of 3-mercaptopropionic acid were added to 17 kg of deionized water to formulate a mixed aqueous solution of a reducing agent and a chain transfer agent; 1,083 kg of Itaconic Acid (IA) was added to 2,000 kg of deionized water to formulate an aqueous itaconic acid solution; the mixed aqueous solution of reducing agent and chain transfer agent above, 40 kg of silane coupling agent (KH-570), and the aqueous itaconic acid solution above were simultaneously and dropwise added to a round-bottom flask, a peristaltic pump was used for controlling that the aqueous itaconic acid solution and KH-570 were dropwise added in 4 h, and the mixed aqueous solution of reducing agent and chain transfer agent was dropwise added in 4.5 h, after completion of the dropwise adding process of all the materials, the heat preservation and stirring were continued for 0.5 h, subsequently cooled to room temperature, a stabilizer sample 2 (with a solid content of 37 wt %) was prepared;

The weight-average molecular weight of the stabilizer sample 2 was measured to be 32,000 g/mol by gel chromatography;

In the stabilizer sample 2, the molar ratio of structural unit

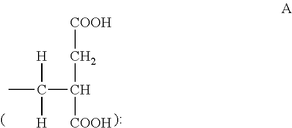

structural unit

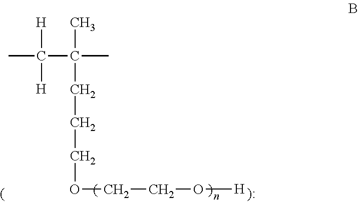

structural unit

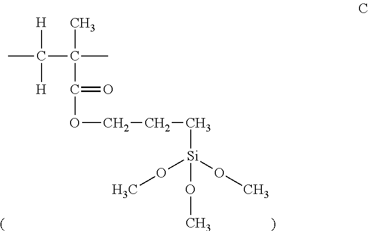

was 2,000:100:400; based on the total weight of the stabilizer sample 2, wherein the content of siloxy (i.e., cross-linkable group) was 1.54 wt % by calculation based on the feeding amount of raw materials.

### Preparation Example 3

100 kg of isopentenol polyoxyethylene ether (TPEG-2400) and 150 kg of deionized water were added to a reaction kettle, stirred and heated to 70° C., preserved the temperature for 1 h; 0.3 kg of hydrogen peroxide (with a concentration of 30 wt %) was added to 15 kg of deionized water, stirred uniformly and then added to the reaction kettle; 1.5 kg of ascorbic acid and 0.2 kg of 3-mercaptopropionic acid were added to 17 kg of deionized water to formulate a mixed aqueous solution of a reducing agent and a chain transfer agent; 9 kg of vinylsulfonic acid was added to 40 kg of deionized water to formulate an aqueous vinylsulfonic acid solution; the mixed aqueous solution of reducing agent and chain transfer agent above, 0.2 kg of vinyloctadecyltrimethoxysilane, and the aqueous vinylsulfonic acid solution above were simultaneously and dropwise added to a round-bottom flask, a peristaltic pump was used for controlling that the aqueous vinylsulfonic acid solution and vinyloctadecyltrimethoxysilane were dropwise added in 4 h, and the mixed aqueous solution of reducing agent and chain transfer agent was dropwise added in 4.5 h, after completion of the dropwise adding process of all the materials, the heat preservation and stirring were continued for 0.5 h, subsequently cooled to room temperature, a stabilizer sample 3 (with a solid content of 33 wt %) was prepared;

The weight-average molecular weight of the stabilizer sample 3 was measured to be 38,000 g/mol by gel chromatography;

In the stabilizer sample 3, the molar ratio of structural unit

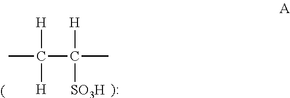

structural unit

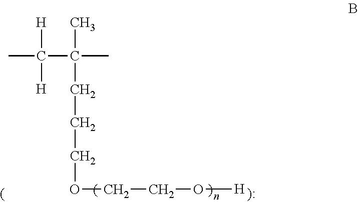

structural unit

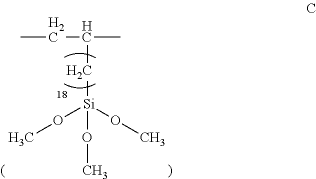

was 200:100:1; based on the total weight of the stabilizer sample 3, wherein the content of siloxy (i.e., cross-linkable group) was 0.04 wt % by calculation based on the feeding amount of raw materials.

### Preparation Example 4

100 kg of 2-acrylamido-2-methylpropane sulfonic acid (AMPS) was added to 200 kg of deionized water and stirred until dissolution, and the pH of the aqueous 2-acrylamido-2-methylpropane sulfonic acid solution was adjusted to 10; heated the solution and raised the temperature to 65° C., 37 kg of itaconic acid was added, and stirring uniformly, 17 kg of a 2,2′-azobis(2-methylpropionamidine) dihydrochloride initiator solution with a mass concentration of 10% and 15 kg of γ-glycidyl ether oxypropyltrimethoxy silane (KH-560) were dropwise added separately; the temperature was slowly raised to 75° C. during the dropwise adding process, after completion of the dropwise adding process of the materials, the reaction was continued for 4 h, subsequently cooled to room temperature, a stabilizer sample 4 (with a solid content of 39 wt %) was prepared;

The weight-average molecular weight of the stabilizer sample 4 was measured to be 27,000 g/mol by gel chromatography;

In the stabilizer sample 4, the molar ratio of structural unit

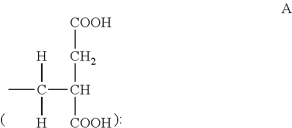

structural unit

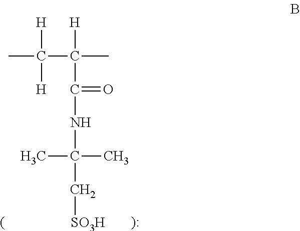

structural unit

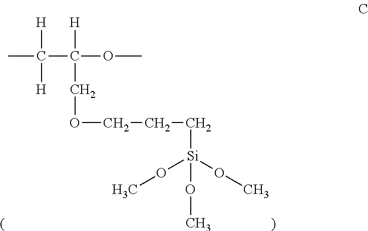

was 59:100:13, based on the total weight of the stabilizer sample 4, wherein the content of siloxy (i.e., cross-linkable group) was 5.56 wt % by calculation based on the feeding amount of raw materials.

### Preparation Example 5

60 g of N-methyl pyrrolidone and 50 g of isopentenol polyoxyethylene ether (TPEG-2400) were weighed, dissolved, and mixed and then placed the mixed solution in a three-port flask in a thermostat water bath pot, stirred the mixed solution at a constant speed of 200 rpm and raised the temperature to 70° C.; 0.7 g of azobisisobutyronitrile was weighed and dissolved in 20 g of N-methyl pyrrolidone, blended uniformly to formulate the solution A; 12 g of 4-vinylphenylboronic acid, 22 g of 2-acrylamido-2-methylpropane sulfonic acid (AMPS), and 1 g of vinyltriacetoxysilane were dissolved in 55 g of N-methyl pyrrolidone, the materials were mixed uniformly to formulate the solution B; the solution A and the solution B were dropwise added to the three-port flask at a constant speed by means of a peristaltic pump, the dropwise adding time was 2 h; after completion of the dropwise adding process, the heat preservation was performed at 60° C. for 2 h and 60 g of water was added at a constant speed for 2 h. After the reaction was completed, the pH of the polymer was adjusted to 9, subsequently cooled to room temperature, and a stabilizer sample 5 (with a solid content of 38 wt %) was prepared;

The weight-average molecular weight of the stabilizer sample 5 was measured to be 60,000 g/mol by gel chromatography;

In the stabilizer sample 5, the molar ratio of the structural unit

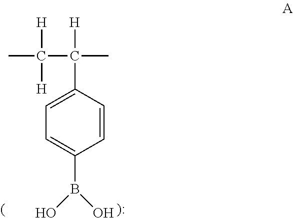

structural unit

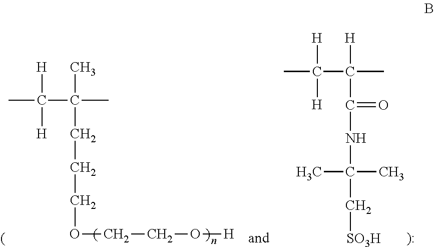

structural unit

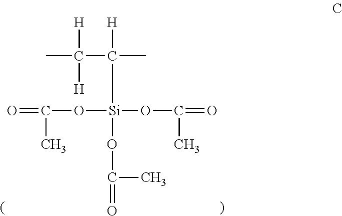

was 389:600:21; based on the total weight of the stabilizer sample 5, wherein the content of siloxy (i.e., cross-linkable group) was 1.17 wt % by calculation based on the 5 feeding amount of raw materials.

### Comparative Preparation Example 1

The stabilizer sample was prepared according to the method in Preparation Example 1, except that the silane coupling agent KH-570 was not added, and the other conditions were the same as those in Preparation Example 1, a stabilizer sample 6 (with a solid content of 40 wt %) was prepared.

### Example 1

The plugging agent composition-1: 20 kg of base latex-1, 2 kg of a stabilizer sample 1, 10 kg of latex pre-polymer-1, and 2 kg of a surfactant OP-10.

According to the proportions of the components in the plugging agent composition-1, the base latex-1, the surfactant OP-10, and water (weight ratio of base latex-1:water was 1:0.4) were added in a reaction kettle and stirred for 30 min; the stabilizer sample 1 was then added and stirred for 15 min; the latex pre-polymer-1 was further added and stirred for 15 min, a plugging agent suspension (denoted as S1) was prepared.

### Example 2

The plugging agent composition-2: 20 kg of base latex-1, 2 kg of a stabilizer sample 2, 10 kg of latex pre-polymer-1, and 2 kg of a surfactant OP-10.

The plugging agent composition-2 and water were used, the same methods and parameters as those in Example 1 were adopted, and a plugging agent suspension (denoted as S2) was prepared.

### Example 3

The plugging agent composition-3: 20 kg of base latex-1, 2 kg of a stabilizer sample 3, 10 kg of latex pre-polymer-1, and 2 kg of a surfactant OP-10.

The plugging agent composition-3 and water were used, the same methods and parameters as those in Example 1 were adopted, and a plugging agent suspension (denoted as S3) was prepared.

### Example 4

The plugging agent composition-4: 20 kg of base latex-1, 2 kg of a stabilizer sample 4, 10 kg of latex pre-polymer-1, and 2 kg of a surfactant OP-10.

The plugging agent composition-4 and water were used, the same methods and parameters as those in Example 1 were adopted, and a plugging agent suspension (denoted as S4) was prepared.

### Example 5

The plugging agent composition-5: 20 kg of base latex-1, 2 kg of a stabilizer sample 5, 10 kg of latex pre-polymer-1, and 2 kg of a surfactant OP-10.

The plugging agent composition-5 and water were used, the same methods and parameters as those in Example 1 were adopted, and a plugging agent suspension (denoted as S3) was prepared.

### Example 6

The plugging agent composition-6: 20 kg of base latex-2, 2 kg of a stabilizer sample 1, 10 kg of latex pre-polymer-2, and 2 kg of a surfactant OP-10.

The plugging agent composition-6 and water were used, the same methods and parameters as those in Example 1 were adopted, and a plugging agent suspension (denoted as S6) was prepared.

### Example 7

The plugging agent composition-7: 20 kg of base latex-1, 6 kg of a stabilizer sample 1, 10 kg of latex pre-polymer-1, and 6 kg of a surfactant OP-10.

The plugging agent composition-7 and water were used, the same methods and parameters as those in Example 1 were adopted, and a plugging agent suspension (denoted as S7) was prepared.

### Example 8

The plugging agent composition-8: 20 kg of base latex-1, 6 kg of purified stabilizer sample 1 (6 kg of stabilizer sample 1 was purified with a dialysis method, the purified liquid obtained was subjected to freeze-drying to obtain 2.33 kg of a solid, which was then dissolved in water to obtain 6 kg of purified stabilizer sample 1), 10 kg of latex pre-polymer-1, and 6 kg of a surfactant OP-10.

The plugging agent composition-8 and water were used, the same methods and parameters as those in Example 1 were adopted, and a plugging agent suspension (denoted as S8) was prepared.

### Example 9

The plugging agent composition-9: 20 kg of base latex-1, 2 kg of a stabilizer sample 1, and 2 kg of a surfactant OP-10.

According to the proportions of the components in the plugging agent composition-9, the base latex-1, the surfactant OP-10, and water (weight ratio of base latex-1:water was 1:0.4) were added in a reaction kettle and stirred for 30 min; the stabilizer sample 1 was then added and stirred for 15 min, and a plugging agent suspension (denoted as S9) was prepared.

### Example 10

The plugging agent composition-10: 10 kg of latex pre-polymer-1, 2 kg of a stabilizer sample 1, and 2 kg of a surfactant OP-10.

According to the proportions of the components in the plugging agent composition-10, the latex pre-polymer-1, the surfactant OP-10, and water (weight ratio of latex pre-polymer-1:water was 1:0.4) were added in a reaction kettle and stirred for 30 min; the stabilizer sample 1 was then added and stirred for 15 min, a plugging agent suspension (denoted as S10) was prepared.

### Comparative Example 1

The plugging agent suspension was prepared according to the method in Example 1, except that the stabilizer sample 1 was excluded from the components of the plugging agent composition-1, and the other conditions were the same as those in Example 1, a plugging agent suspension (denoted as D1) was prepared.

### Comparative Example 2

The plugging agent suspension was prepared according to the method in Example 1, except that the stabilizer sample 1 in the components of the plugging agent composition-1 was replaced by an equal weight of silane coupling agent KH-570, and the other conditions were the same as those in Example 1, a plugging agent suspension (denoted as D2) was prepared.

### Comparative Example 3

The plugging agent suspension was prepared according to the method in Example 1, except that the stabilizer sample 1 in the components of the plugging agent composition-1 was replaced by an equal weight of a stabilizer 6 prepared in the Comparative Example 1, and the other conditions were the same as those in Example 1, a plugging agent suspension (denoted as D3) was prepared.

### Test Examples

### Test Example 1: Stability and Temperature Resistance Testing

The plugging agent suspensions S1-S10, and D1-D3 prepared in the aforementioned Examples 1-10 and Comparative Examples 1-3 were subjected to aging by using a high-pressure hydrothermal kettle at an aging temperature of 120° C. and an aging time of 16 h, the results were shown in Table 1.

TABLE 1

| Testing objects | Status after aging at 120° C. for 16 h |
|---|---|
| Plugging agent suspension S1 | Maintaining a stable state, ungelled |
| Plugging agent suspension S2 | Maintaining a stable state, ungelled |
| Plugging agent suspension S3 | Maintaining a stable state, ungelled |
| Plugging agent suspension S4 | Maintaining a stable state, ungelled |
| Plugging agent suspension S5 | Maintaining a stable state, ungelled |
| Plugging agent suspension S6 | Maintaining a stable state, ungelled |
| Plugging agent suspension S7 | Maintaining a stable state, ungelled |
| Plugging agent suspension S8 | Maintaining a stable state, ungelled |
| Plugging agent suspension S9 | Maintaining a stable state, ungelled |
| Plugging agent suspension S10 | Maintaining a stable state, ungelled |
| Plugging agent suspension D1 | Exhibiting a gelatinous state |
| Plugging agent suspension D2 | Exhibiting a gelatinous state |
| Plugging agent suspension D3 | Maintaining a stable state, ungelled |

As illustrated by Table 1, the plugging agent suspensions S1-S10 can maintain a stable state and do not thicken and gelatinize after aging at 120° C. for 16 h, indicating that in the absence of cracks and/or leakage points, the stabilizer samples of the present disclosure may maintain the stable existence of polymer latex, and exhibit desirable high-temperature resistance.

### Test Example 2: Test for Plugging Cracks Having a Width of 10 μm

The plugging performance evaluation of the plugging agents was implemented using the Fann permeability plugging apparatus (PPA type) manufactured in the United States of America (USA), and the instrument was equipped with filtration loss media having various specifications, such as sand disks, ordinary filter paper, or crack stainless steel discs, the filtration loss media having various specifications were used for simulating cracks of different sizes ranging from 10 μm to several millimeters, the instrument can provide a maximum test temperature of 260° C. and a maximum test pressure of 34.5 MPa.

Test method: a sand disk containing cracks having a width of 10 μm was selected, 300 mL of the plugging agent suspensions S1-S10, D1-D3 prepared in Examples 1-10, and Comparative Examples 1-3 were added into the permeability plugging apparatus, respectively, the test temperature of the permeability plugging apparatus was then adjusted to 100° C., the pressurization was started from 0.5 MPa, and the pressure was increased by 0.5 MPa for each time, until the pressure was raised to 12 MPa, and the pressure was increased by 0.5 MPa after the plugging agent suspension maintained a drip or there was no lost circulation for 30 min under each pressure condition. The plugging results of the sand disk containing cracks having a width of 10 μm by the plugging agent suspensions S1-S10, D1-D3 were shown in Table 2.

TABLE 2

| | Bearable | Lost |
|---|---|---|
| | pressure at | circulation |
| Testing objects | 100° C./MPa | amount/mL |
| Plugging agent suspension S1 | 12 | 80 |
| Plugging agent suspension S2 | 12 | 95 |
| Plugging agent suspension S3 | 12 | 97 |
| Plugging agent suspension S4 | 12 | 100 |
| Plugging agent suspension S5 | 12 | 105 |
| Plugging agent suspension S6 | 12 | 85 |
| Plugging agent suspension S7 | 12 | 90 |
| Plugging agent suspension S8 | 12 | 88 |
| Plugging agent suspension S9 | 12 | 95 |
| Plugging agent suspension S10 | 7 | 172 |
| Plugging agent suspension D1 | / | / |
| Plugging agent suspension D2 | / | / |
| Plugging agent suspension D3 | 3.5 | 181 |

As can be seen from Table 2, the plugging agent suspensions formulated with plugging agent compositions provided by the present disclosure have excellent plugging properties for small cracks with a micrometer scale (e.g., cracks with a width of 10 μm), the lost circulation amount is not higher than 105 mL, the cured product can withstand a pressure up to 12 MPa at 100° C. D1 and D2 cannot be used as plugging agents. D3 has a poor plugging effect with a large lost circulation amount.

### Test Example 3: Test for Plugging Cracks Having a Width of 250 μm

The plugging agent suspensions S1-S10 and D1-D3 were subjected to the plugging performance testing by using the Fann permeability plugging apparatus (PPA type) manufactured in the United States of America (USA) according to the method in the Test Example 2, except that a sand disk containing cracks having a width of 250 μm was used, the other steps and conditions were the same as those in the Test Example 2, and the results were shown in Table 3.

TABLE 3

| | Bearable | Lost |
|---|---|---|
| | pressure at | circulation |
| Testing objects | 100° C./MPa | amount/mL |
| Plugging agent suspension S1 | 12 | 108 |
| Plugging agent suspension S2 | 12 | 121 |
| Plugging agent suspension S3 | 12 | 136 |
| Plugging agent suspension S4 | 12 | 145 |
| Plugging agent suspension S5 | 12 | 152 |
| Plugging agent suspension S6 | 12 | 110 |
| Plugging agent suspension S7 | 12 | 155 |
| Plugging agent suspension S8 | 12 | 152 |
| Plugging agent suspension S9 | 1.5 | 181 |
| Plugging agent suspension S10 | 10 | 145 |
| Plugging agent suspension D1 | / | / |
| Plugging agent suspension D2 | / | / |
| Plugging agent suspension D3 | 2.5 | 181 |

As can be seen from Table 3, the plugging agent suspensions formulated with plugging agent compositions provided by the present disclosure have excellent plugging properties for cracks with a width of 250 μm, the lost circulation amount is not higher than 180 mL, the cured product can withstand a pressure up to 10 MPa at 100° C. D1 and D2 cannot be used as plugging agents. D3 has a poor plugging effect with a large lost circulation amount.

### Test Example 4: Test for Plugging Cracks Having a Width of 2 mm

Formulation of the plugging slurries: the plugging slurries were formulated by adding 1 kg of walnut shell (with a particle size of 270-350 μm), 1 kg of elastic rubber (with a particle size of 780-850 μm), and 500 g of polypropylene fibers (with a fiber length of 30-40 mm) to 20 kg of the plugging agent suspensions S1-S10 and D1-D3 prepared in Examples 1-10 and Comparative Examples 1-3, respectively, and stirring for 15 min.

The plugging slurries above were subjected to the plugging performance testing by using the Fann permeability plugging apparatus (PPA type) manufactured in the United States of America (USA) according to the method in Test Example 2, except that a sand disk containing cracks having a width of 2 mm was used, and the test temperature was 120° C., the other steps and conditions were the same as those in the Test Example 2, and the results were shown in Table 4.

TABLE 4

| | Bearable | Lost |
|---|---|---|
| | pressure at | circulation |
| Testing objects | 100° C./MPa | amount/mL |
| Plugging agent suspension S1 + walnut | 12 | 55 |
| shell + elastic rubber + fiber | | |
| Plugging agent suspension S2 + walnut | 12 | 62 |
| shell + elastic rubber + fiber | | |
| Plugging agent suspension S3 + walnut | 12 | 59 |
| shell + elastic rubber + fiber | | |
| Plugging agent suspension S4 + walnut | 12 | 65 |
| shell + elastic rubber + fiber | | |
| Plugging agent suspension S5 + walnut | 12 | 66 |
| shell + elastic rubber + fiber | | |
| Plugging agent suspension S6 + walnut | 12 | 61 |
| shell + elastic rubber + fiber | | |
| Plugging agent suspension S7 + walnut | 12 | 70 |
| shell + elastic rubber + fiber | | |
| Plugging agent suspension S8 + walnut | 12 | 69 |
| shell + elastic rubber + fiber | | |
| Plugging agent suspension S9 + walnut | 12 | 97 |
| shell + elastic rubber + fiber | | |
| Plugging agent suspension S10 + | 12 | 93 |
| walnut shell + elastic rubber + fiber | | |
| Plugging agent suspension D1 + walnut | / | / |
| shell + elastic rubber + fiber | | |
| Plugging agent suspension D2 + | / | / |
| walnut shell + elastic | | |
| rubber + fiber | | |
| Plugging agent suspension D3 + walnut | 4 | 140 |
| shell + elastic rubber + fiber | | |

As can be seen from Table 4, the plugging agent suspensions formulated with plugging agent compositions provided by the present disclosure in combination with the bridging materials (walnut shell, elastic rubber, and polypropylene fibers) have excellent plugging effects for cracks with a width of 2 mm, the cured product can withstand a pressure up to 12 MPa at 120° C., and the lost circulation amount is not higher than 100 mL. D1 and D2 were gelled under the temperature condition of 120° C. and cannot effectively plug cracks having a width of 2 mm even in combination with the bridging materials. D3 has a poor plugging effect with a large lost circulation amount. The above content describes in detail the preferred embodiments of the invention, but the invention is not limited thereto. A variety of simple modifications can be made in regard to the technical solutions of the invention within the scope of the technical concept of the invention, including a combination of individual technical features in any other suitable manner, such simple modifications and combinations thereof shall also be regarded as the content disclosed by the invention, each of them falls into the protection scope of the invention.

1-16. (canceled)

17. A plugging agent composition comprising polymer latex and a stabilizer, wherein the stabilizer has a cross-linkable group and/or a couplable group; the cross-linkable group and/or the couplable group in the stabilizer are/is cross-linked or coupled in the presence of a crack and/or a leakage point so that the polymer latex is coagulated and cured.

18. The composition of claim 17, wherein the cured product is capable of withstanding a pressure of not less than 5 MPa.

19. The composition of claim 17, wherein the concentration of metal cations in the composition is below 0.1 wt %.

20. The composition of claim 18, wherein the composition does not contain a metal cation demulsifier.

21. The composition of claim 17, wherein a weight ratio of polymer latex:stabilizer is 1:(0.0001-0.2).

22. The composition of claim 17, wherein the content of a cross-linkable group and/or a couplable group in the stabilizer is within the range of 0.001-20 wt %, based on the total weight of the stabilizer.

23. The composition of claim 22, wherein the cross-linkable group and/or the couplable group is siloxy.

24. The composition of claim 23, wherein the stabilizer further comprises at least one of the groups 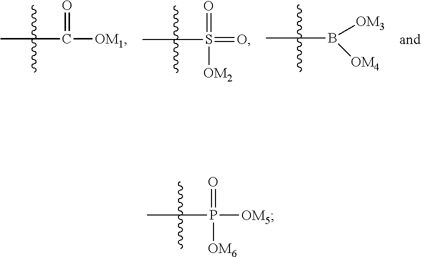
wherein M₁, M₂, M₃, M₄, M₅, and M₆ are each independently selected from H⁺, Na⁺, K⁺, or NH₄⁺;
and/or, the stabilizer has a weight average molecular weight within the range of 10,000-100,000 g/mol.

25. The composition of claim 23, wherein the stabilizer has a structural unit A represented by formula (1), a structural unit B represented by formula (2) or formula (3), and a structural unit C represented by formula (4) or formula (5); 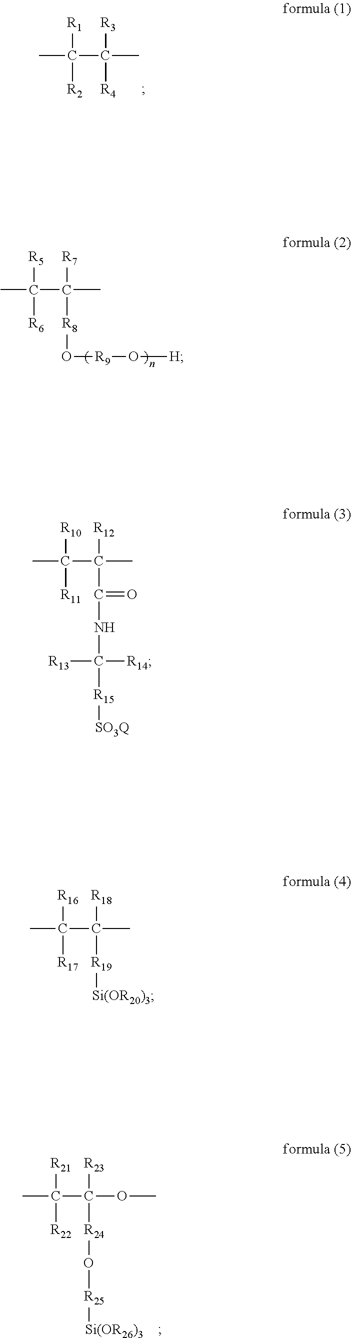
wherein R₁, R₂, R₃, and R₄ in formula (1) are each independently selected from —H, —CH₃, —COOM¹, —SO₃M², —CH₂COOM³, —CH₂SO₃M⁴, 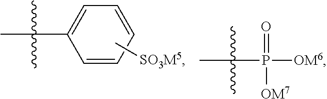
or —CONHC(CH₃)₂CH₂SO₃M⁸, R₁, R₂, R₃, and R₄ are not selected from —H or —CH₃ simultaneously;
wherein M¹, M², M³, M⁴, M⁵, M⁶, M⁷, and M⁸ are each independently selected from H⁺, K⁺, Na⁺, or NH₄⁺;
R₅, R₆, and R₇ in formula (2) are each independently selected from —H or C₁-C₁₈ alkyl; R₈ is selected from C₁-C₃ alkylene; and R₉ is selected from C₁-C₃ alkylene;
R₁₀, R₁₁, R₁₂, R₁₃, and R₁₄ in formula (3) are each independently selected from —H, or C₁-C₄ alkyl; R₁₅ is selected from C₁-C₄ alkylene; Q is selected from H⁺, K⁺, Na⁺, or NH₄⁺;
R₁₆, R₁₇, and R₁₈ in formula (4) are each independently selected from —H, or C₁-C₁₈ alkyl; R₁₉ is selected from a chemical bond, C₁-C₁₈ alkylene, or —COOCH₂CH₂CH₂—; R₂₀ is selected from C₁-C₂ alkyl, —CH₂OCH₃, or —CH₂CH₂OCH₃;
R₂₁, R₂₂, and R₂₃ in formula (5) are each independently selected from —H, or C₁-C₁₈ alkyl; R₂₄ is selected from C₁-C₁₈ alkylene; R₂₅ is selected from C₁-C₃ alkylene; and R₂₆ is selected from C₁-C₂ alkyl;
the molar ratio of structural unit A:structural unit B:structural unit C is within the range of (1-2,000):100:(0.01-400).

26. The composition of claim 17, wherein the polymer latex is at least one selected from the group consisting of nitrile latex, styrene-butadiene latex, styrene-propylene latex, butyl latex, pure propylene latex, neoprene latex, natural rubber latex, fluororubber latex, polybutadiene latex, ethylene propylene diene monomer (EPDM) latex, silicone rubber latex, and polyacrylate latex.

27. The composition of claim 17, wherein the polymer latex comprises latex particles having a particle size of 20-300 nm and/or latex particles having a particle size of 300 nm-2 mm.

28. The composition of claim 17, wherein the composition further comprises a surfactant.

29. The composition of claim 28, wherein the surfactant is selected from anionic surfactants and/or non-ionic surfactants.

30. The composition of claim 28, wherein the weight ratio of polymer latex:surfactant is 1:(0.0001-0.2).

31. The composition of claim 17, wherein the composition further comprises a bridging material.

32. The composition of claim 31, wherein the bridging material is at least one selected from the group consisting of walnut shell, elastic particles, and fibrous material;
and/or, the weight ratio of polymer latex:bridging material is 1:(0.001-1).

33. The composition of claim 32, wherein the walnut shell has a particle size within the range of 150-450 μm; the elastic particles have a particle size within the range of 450-850 μm; and
the fibrous material has a fiber length within the range of 5-40 mm.

34. A method of using the plugging agent composition of claim 17 in lost circulation control of a hydrocarbon reservoir.

35. A hydrocarbon reservoir plugging method comprising the following steps: injecting the plugging agent composition of claim 17 into a hydrocarbon reservoir formation, the composition flows into a crack and/or a leakage point of the oil and gas reservoir formation during the injection process, and is coagulated and cured at the crack and/or leakage point to form a cured product capable of withstanding a pressure of not less than 5 MPa at a temperature of 100° C.

36. The method of claim 17, wherein the temperature of the hydrocarbon reservoir formation is within the range of 30-120° C.;
and/or, the crack has a width within the range of 20 nm-2 mm; the leakage point has a size within the range of 20 nm-300 nm.
